(19) United States
(12) Patent Application Publication
(10) Pub. No.: US 2006/0005378 A1
(43) Pub. Date: Jan. 12, 2006

(54) Apparatus and method for demounting and mounting an integrated circuit

(75) Inventor: Yeh Chia Chan, Kaohsiung (TW)

Correspondence Address: BEVER HOFFMAN & HARMS, LLP;TRI-VALLEY OFFICE, 1432 CONCANNON BLVD., BLDG. G, LIVERMORE, CA, 94550, US

(73) Assignee: Arima Display Corp., Taipei (TW)

(21) Appl. No.: 10/887,622

(22) Filed: Jul. 8, 2004

(51) Int. Cl. B23P 19/00

(52) U.S. Cl. 29/739; 29/744; 29/740; 29/832; 414/737

(57) ABSTRACT

An apparatus for demounting and mounting for an integrated circuit, includes a base having a arm, a platform disposed on the base, a tooling head disposed on the arm, and a positioning device disposed on the base. The platform and the positioning device horizontally move together and a linking portion of a combination of a integrated circuit, and display, disposed on the platform and the positioning device, is moved under the tooling head and then pressed by the tooling head when the tooling head descends to press the linking portion. And both of the platform and the positioning device move back so that the tooling head scrapes the integrated circuit from the display.

### FIELD OF THE INVENTION

The present invention is related to an apparatus, and more particularly, to an apparatus for use in demounting and mounting an integrated circuit.

### BACKGROUND OF THE INVENTION

When producing a display panel, for instance, the display panel for mobile phone, the integrated circuit is electrically connected to the display panel. As such, the integrated circuit is enabled to control the action of the display panel. However, in practice, the display panel or the integrated circuit might malfunction. Therefore, for finding out the where the problem is, it is necessary to demount the integrated circuit from the display panel for further test.

Thus, for demounting the integrated circuit from the display panel, it is better to use specially made apparatus in order to avoid any error by bare hand job.

Please refer to FIG. 1. FIG. 1 is a schematic view of the conventional apparatus for mounting and demounting an integrated circuit. The conventional apparatus includes a base 3 and a back positioning device 20 and a platform 10 disposed on the base 3. And the combination of the integrated circuit 7 and the display panel 6 is placed on the apparatus, in which the integrated circuit 7 is on the back positioning device 20 and the display panel 6 is on the platform 10. In the combination, the pins 71 of the integrated circuit 7 and the terminals 61 of the display panel 6 are electrically connected to each other. Furthermore, the rail 32 is disposed on the base 3 for the platform 10 and the back positioning device 20 moving thereon. The base 3 has an arm 40 for hanging a tooling head above the base 3.

Please refer to FIG. 1. While the display panel 6 malfunctions, the integrated circuit 7 needs to be demounted therefrom. First, the combination of the integrated circuit 7 and the display panel 6 are placed on the apparatus, in which the integrated circuit 7 is fixed on the back positioning device 20 and the display panel 6 is fixed on the platform 10. Then, the arm 40 moves in the direction X toward the back positioning device 20 for being positioned above the platform 10 until the tooling head 4 is right above the linking portion 9 between the display panel 6 and the integrated circuit 7. Next the tooling head 4 descends into the linking portion 9 in the direction Y and urges against thereon. The tooling head 4 descending into the linking portion 9 is to make the tooling head 4 enable to urge against the integrated circuit 7 when the arm 40 moves back in the direction X′. At last, the arm 40 moves in the direction X′ and backs to the position as shown in FIG. 1. Since the tooling head 4 has already urged against the integrated circuit 7 while the arm 40 moves back toward the original position, the integrated circuit 7 was scraped from the display panel 6 by the tooling head 4. Furthermore, for easily scrapping the integrated circuit 7 from the display panel 6, it is common to heat the linking portion 9 in order to make the conductive glue between the pins 71 and terminals 61 melted. The conductive glue is usually heated by the back positioning device 20 through the integrated circuit 7 thereon. The heat is transferred to the integrated circuit 7 and then to the pins 71 by the back positioning device 20, so, the conductive glue between the pins 71 and terminals 61 is melted. As such the mechanical strength of the glue is dropped so that the integrated circuit 7 is scraped from the display panel 6 by the tooling head 4.

However, the conventional apparatus still has some defects. First, the tooling head 4 is an item determining two fixed positions while moving both horizontally and vertically. So, the error is cumulative by the errors resulted from the arm 40 and the tooling head 4. In other words, the rigidity of the conventional apparatus is not enough and the accuracy of the position of the tooling head 4 is hard to achieve.

Furthermore, the conventional apparatus has no device for fine-tune function. The positioning in horizontal direction only depends on the rail 32. Nevertheless, the rail 32 is determining factor for the moving of the arm 40 which scrapes the integrated circuit 7 from the display panel 6. Therefore in practice, it is difficult to process the scraping and the fine-tuning simply by one mechanism, because the mechanism for scraping needs high power but not accurate positioning. Therefore, the operator often gets hurt by the arm 40 and the back positioning device 20, when he/she adjusts the position of the arm 40 on the rail 32. On the other hand, the tooling head 4 sometimes clashes against the display panel 6 or the integrated circuit 7 during the adjustment of the arm 40.

The mechanism with fine-tuning function is not proper for the scraping either. Since during the scrapping, while the arm 40 moves along the X′ direction, the rail 32 receives the stress in the X direction and the deformation might occur. So, during a long term and heavy duty operation, the backlash inside the fine-tuning mechanism will be increased. And the accuracy will drop. Therefore, the cost will be unavoidably higher.

Furthermore, the conventional apparatus for demounting the integrated circuit is not made in a modular way. So, when the size of the integrated circuit or the display panel is changed, the back positioning device and the platform need to be replaced. It is very troublesome. Furthermore, the platform of the conventional apparatus has no enough vacuum holes for fitting various sizes of the display panels. With regard to the tooling head of the conventional apparatus, the tooling head is unable to adjust the pressure applied to the integrated circuit. The parallelism of the tooling head is also difficult to be adjusted because the arm is movable on the rail that the rigidity between the arm and the base is low Even though the parallelism is adjusted, it can not be maintain for a long term.

Therefore, it is important to supply an unique apparatus for mounting and demounting the integrated circuit from the display panel.

### SUMMARY OF THE INVENTION

It is an object of the present invention to provide an apparatus to demount and mount an integrated circuit, which is flexible, convenient, and fast for positioning and highly stable for long term use and heavy duty processes.

According to one aspect of the present invention, an apparatus for demounting and mounting an integrated circuit, includes a base having an arm, a platform disposed on the base and horizontally moving thereon, a tooling head disposed on the arm and hung above the base for approaching to and moving away from the platform, and a positioning device disposed on the base and moving with the platform.

In accordance with the present invention, the tooling head further includes a pressure moderator for adjusting a pressure supplied by the tooling head.

In accordance with the present invention, the apparatus further includes an altitude adjustor disposed between the base and the platform.

In accordance with the present invention, the apparatus further includes a controller to control a process for scraping and pressing the integrated circuit.

In accordance with the present invention, the apparatus further includes a position adjustor for adjusting a position of the positioning device.

According to one aspect of the present invention, a method for demounting an integrated circuit, includes steps of (a) placing a combination of a display panel and an integrated circuit at a first location, wherein the integrated circuit is placed on a positioning device and the display panel is placed on a platform, (b) moving the positioning device and the platform to a second location such that a linking portion between the display panel and the integrated circuit is positioned under a tooling head, (c) descending the tooling head for urging against the link portion; and (d) moving the positioning device and the platform back to the first location, thereby the integrated circuit being scraped from the display panel.

In accordance with the present invention, the method further comprises a step (b-1) for heating the integrated circuit to soften a glue stuck on the link portion.

In accordance with the present invention, the linking portion is heated by the positioning device.

In accordance with the present invention, the linking portion is heated by the tooling head.

According to one aspect of the present invention, a method for mounting an integrated circuit, includes steps of (a) placing a combination of a display panel and an integrated circuit at a first location, wherein the integrated circuit is placed on a positioning device and the display is placed on a platform, (b) moving the positioning device and the platform to a second location so that a linking portion between the display panel and the integrated circuit is under a tooling head, (c) descending the tooling head for urging against the link portion for a period of time, (d) raising the tooling head after the period of time, and (e) moving the positioning device and the platform back to the first location.

In accordance with the present invention, the method further includes a step (b-1) for heating the integrated circuit to soften a glue stuck on the link portion.

In accordance with the present invention, the linking portion is heated by the positioning device.

In accordance with the present invention, the linking portion is heated by the tooling head.

The foregoing and other features and advantages of the present invention will be more clearly understood through the following descriptions with reference to the drawings, wherein:

### BRIEF DESCRIPTION OF THE DRAWINGS

FIG. 1 is a schematic view of the conventional apparatus for demounting and demounting an integrated circuit;

FIG. 2 is a schematic view of the apparatus for demounting and demounting an integrated circuit according to a preferred embodiment of the present invention;

FIG. 3 is a side view showing the operation for demounting/mounting the integrated circuit according to a preferred embodiment of the present invention;

FIG. 4 is a side view showing the operation for demounting/mounting the integrated circuit according to a preferred embodiment the present invention; and

FIG. 5 is a side view showing the operaction for demounting/mounting the integrated circuit according to a preferred embodiment of the present invention.

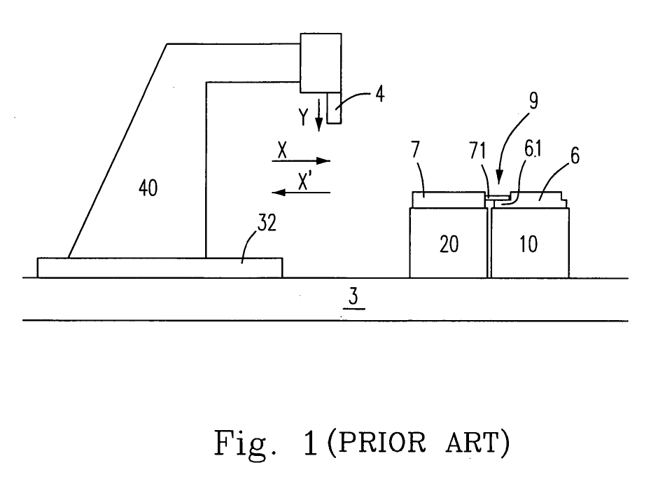

### DETAILED DESCRIPTION OF THE PREFERRED EMBODIMENT

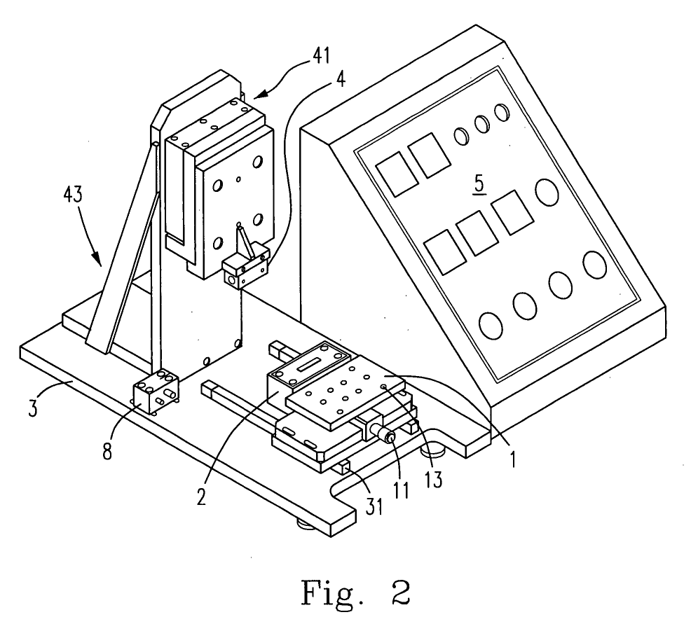

The present invention will now be described more specifically with reference to the following embodiments. Please refer to FIG. 2. FIG. 2 is a schematic view of the apparatus for demounting and demounting an integrated circuit according to a preferred embodiment of the present invention. The present invention includes a base 3 and a platform 1 disposed thereon. The platform 1 is able to move horizontally along the base 3. In other words, the platform 1 moves towards or away from the arm 43 disposed on base 3. The arm 43 has a tooling head 4 hanging above the platform 1 and moving up and down towards or away from the platform 1. Furthermore, a positioning device 2 is disposed on the base 3 and moves with the platform 1 along the base 3.

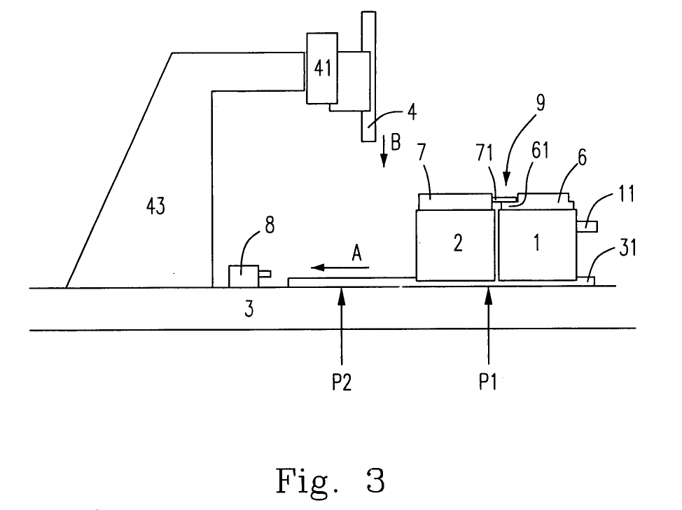

Please still refer to FIG. 2. For accurately positioning the platform 1 and the positioning device 2, the position adjustor 8 is further disposed on the base 3 for accurately adjusting the positions of the platform 1 and the positioning device 2. The platform 1 and the positioning device 2 move on the rail 31 disposed on the base 3. The altitude adjustor 11 is disposed between the rail 31 and the platform 1 for adjusting the altitude of the platform 1. And the platform 1 has plural vacuum holes 13 thereon for sucking the display panel 6 (FIG. 3). Each of the vacuum holes 13 has various size. Furthermore, the present apparatus is connected to a controller 5 (FIG. 3) to control the parameters of the processes for demounting and mounting. The pressure moderator 41 is disposed between the tooling head 4 and the arm 43, and the pressure thereof is preset and controlled by the controller 5. When the pressure reaches the preset value, the tooling head 4 will stop descending immediately and then start raising, or just be decontrolled from mounting/demounting process. When the tooling head 4 is decontrolled, the tooling head 4 is able to move freely by external force for preventing clashing against the integrated circuit 7 or the display panel 6 (FIG. 3) if the pressure is too large.

Please refer to FIG. 3. FIG. 3 is a side view showing the operation for demounting/mounting the integrated circuit according to a preferred embodiment of the present invention. The integrated circuit 7 and the display panel 6 are combined to each other. The display panel 6 is placed on the platform 1 and the integrated circuit 7 is placed on the positioning device 2. In the combination of the integrated circuit 7 and the display panel 6, the pins 71 of the integrated circuit 7 and the terminals 61 of the display panel 6 are electrically connected together. In FIG. 3, the platform 1 and the positioning device 2 are in the first location P1 and meanwhile the integrated circuit 7 and the display panel 6 are placed thereon.

At the first location P1, because the integrated circuit 7 and the display panel 6 have various sizes, the platform 1 or the positioning device 2 needs to be replaced to fit them. After the proper platform 1 or the positioning device 2 is chosen, the altitude of the platform 1 is adjusted by the altitude adjustor 11 to make sure that both of the integrated circuit 7 and the terminals 61 are fixedly sucked and placed on the positioning device 2 and the platform 1.

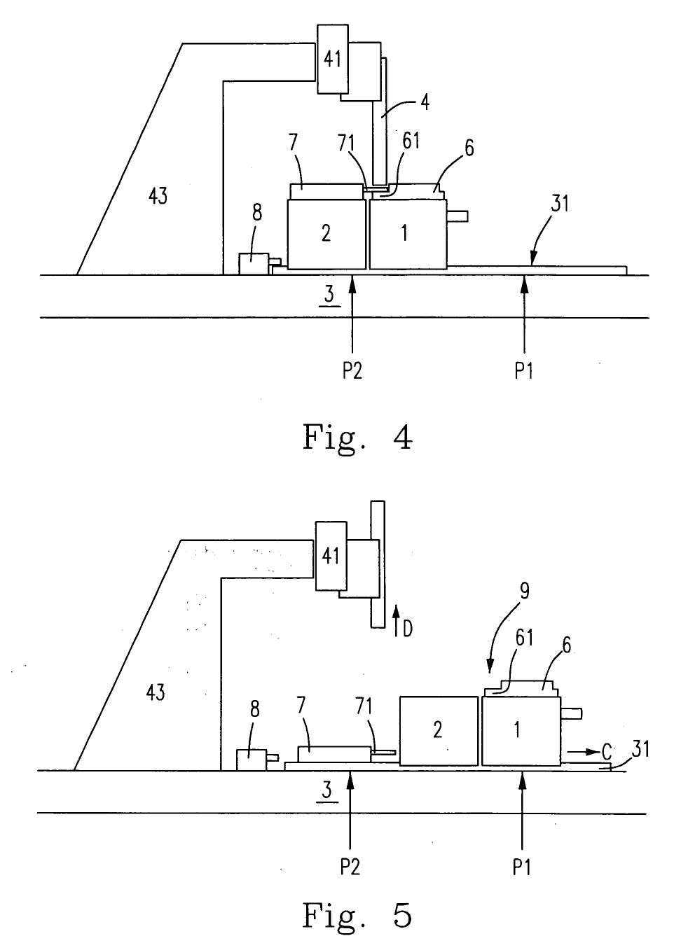

Afterwards, the position of the linking portion 9 is relatively different owing to the varieties of the integrated circuit 7 and the display panel 6 in every mounting/demounting process. Therefore, the platform 1 is moved to the second location P2 (FIG. 4) in the direction A through the manual control. And then, by the position adjustor 8, the position of the linking portion 9 is fine tuned and moved exactly right below the tooling head 4. Furthermore, because of the various sizes or scales of the display panel 6, the relative vacuum hole 13 is accordingly activated for sucking the display panel 6. The position of the platform 1 is also adjusted at the location P1 and the location P2.

Further, that according to the various types of the integrated circuit 7, the pressure supplied by the tooling head 4 is preset by the controller 5. The controller 5 records and integrates the former settings for the automatic mounting and demounting processes. In other words, when the present apparatus is employed with the same type of the integrated circuit 7 and display panel 6 next time, the platform 1 and the tooling head 4 need no adjustment at all and the automatic mounting/demounting process can be directly performed.

The scraping process, also called demounting process, is described as follows. After all of the adjustments and settings are predetermined and set, the controlling mode is changed from manual control to automatic control. The combination of the integrated circuit 7 and the display panel 6 is placed on the positioning device 2 and the platform 1 and the positioning device 2 is located on the location P1. The vacuum hole 13 is activated for fixedly sucking the display panel 6.

Please refer to FIGS. 3-5. FIG. 3-5 are the side views showing the action for demounting/mounting the integrated circuit according to a preferred embodiment of the present invention. First, the platform 1 and the positioning device 2 are moved together in the direction A to the location P2 from the location P1. While the platform 1 and the positioning device 2 are located at the location P2, the tooling head 4 is descending into the link portion 9 in the direction B and urging against the pins 71 by the preset pressure. And the platform 1 and the positioning device 2 are moved back to location P1 together. Because of the interference of the tooling head 4, the integrated circuit 7 is stopped at the location P2. Therefore, the pins 71 is separated from the terminals 61 and drops without the suspension of the positioning device 2 when the positioning device 2 is moved back to the location P1. While the platform 1 and the positioning device 2 are moved back and stop at the location P1, the tooling head 4 is raised back in the direction D to the position before descending. And the display panel 6 is removed by hands.

The aforesaid steps are the basic process for demounting the integrated circuit 7 from the display panel 6. However, the integrated circuit 7 is linked with the display panel 6 by the heat-melted conductive glue. Therefore, the glue at the linking portion 9 must to be melted to decrease the strength thereof. Usually the glue is heated by the positioning device 2 through heating the integrated circuit 7. When the integrated circuit 7 is heated, the heat is transferred to the pins 71, then transfer to the glue, until the glue is melted. Thus, the integrated circuit 7 is able to be scraped from the display panel 6.

According to the present invention, because the arm 43 is fixed on the base 3 and does not move horizontally, the tooling head 4 is free from the problems of cumulative errors. Although the locations of the platform 1 and the positioning device 2 are affected by the stress during the processes, it can be easily solved by the position adjustor 8.

Except what are described in the above, the present apparatus can be employed for the mounting process of the integrated circuit 7 onto the display panel 6, which is called the chip on glass (COG) process.

Please refer to FIG. 3. FIG. 3 is a side view showing the action for demounting/mounting the integrated circuit according to a preferred embodiment of the present invention. Because of the variety types of the integrated circuit 7 and the display panel 6, basically the positioning device 2 needs to be replaced accordingly. Then the platform 1 is descended or raised by the altitude adjustor 11 to match the position of the display panel 6.

Afterwards, the position of the linking portion 9 is relatively different owing to the varieties of the integrated circuit 7 and the display panel 6 in every mounting/demounting process. Therefore, the platform 1 is moved to the second location P2 (FIG. 4) in the direction A through the manual control. And then, by the position adjustor 8, the position of the linking portion 9 is fine tuned and moved exactly right below the tooling head 4. Furthermore, because of the various types of the display panel 6, the relative vacuum hole 13 is activated for fixedly sucking the display panel 6. The position of the platform 1 is accordingly also adjusted at the location P1 and location P2.

And then according to the different types of the integrated circuit 7, the pressure and the period of time for pressing of the tooling head 4 are preset. The controller 5 records and integrates the former every settings for the automatic mounting processes. In other words, when the present apparatus is employed with the same type of the integrated circuit 7 and display panel 6 next time, the platform 1 and the tooling head 4 need no adjustment at all and the automatic mounting process can be directly performed.

After all of the adjustments and settings are preset, the controlling mode is changed from manual mode to automatic mode. The integrated circuit 7 and the display panel 6 are placed individually on the positioning device 2 and the platform 1, and meanwhile the positioning device 2 is located on the location P1. The vacuum hole 13 is activated for fixedly sucking the display panel 6. In the meantime, the glue is disposed between the pins 71 and the terminals 61.

Please refer to FIGS. 3-4. FIGS. 3-4 are the side views showing the action for demounting/mounting the integrated circuit according to a preferred embodiment of the present invention. Now the mounting process is described as follows. First, the platform 1 and the positioning device 2 are moved together in the direction A to the location P2 from the location P1. While the platform 1 and the positioning device 2 are located at the location P2, the tooling head 4 is descending into the link portion 9 in the direction B and urging against the pins 71 for a period of time by the preset pressure. When the period of time is reached, the tooling head 4 is raised in the direction D and the platform 1 and the positioning device 2 are moved back to location P1 together. Therefore, the integrated circuit 7 and the display panel 6 are accordingly linked by the glue as a piece of combination. The combination of the integrated circuit 7 and the display panel 6 is removed by hands.

As the above, the integrated circuit 7 is linked with on the display panel 6 by the heat-melted conductive glue. However, the glue must be melted on the linking portion 9 and fully spread between the pins 71 and the terminals 61. Usually the glue is heated when the integrated circuit 7 is heated by the positioning device 2. When the integrated circuit 7 is heated, the heat is transferred to the pins 71, then transferred to the glue, so the glue is melted and fully spread therebetween.

The pressure supplied by the tooling head 4 is not only to confirm that the pins 71 are firmly urged against the terminals 61, but also to make the pins 71 to compress the microcapsules (not shown) in the glue. Therefore, the metal grains (not shown) inside the microcapsules can flow out and be electrically connected to the pins 71 and the terminals 61. On the contrary, when the microcapsules without being compressed by the pins 71 are not broken, the short cut between the pins 71 or the terminals 61 will not occur. Furthermore, the other portion of the glue (other than the microcapsules) has function of connecting the pins 71 and the terminals 61 mechanically.

According to abovementioned descriptions, the main object of the present invention is to demount the integrated circuit 7 from the display panel 6. And another function is to mount the integrated circuit 7 on the display panel 6, such as the COG process or the ACF sub-engineer, for the reproduction, test, or foregoing of the products.

There are many advantageous in the present invention. About the platform 1, because the vacuum holes 13 disposed thereon are corresponding to the particular types of the display panel 6, only the vacuum holes 13 suiting to the specific type of the display panel 6 need to be activated and the platform 1 needs not to be replaced unless the display panel 6 is to large. Currently the platform 1 of the present invention is suitable for any types of display panels 6 with sizes from one inch to six inches.

Furthermore, the present invention includes an altitude adjustor between the base and the platform. Because of the different thickness of the polarizing filter of various types of the display panel, the altitude of the platform can be changed by the altitude adjustor. Therefore, the platform needs not to be replaced. Thus the time-consuming process and the cost are significantly decreased by applying the present invention.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. An apparatus for demounting and mounting an integrated circuit, comprising:
a base having an arm;
a platform disposed on said base and horizontally moving thereon;
a tooling head disposed on said arm and hung above said base for approaching to and moving away from said platform; and
a positioning device disposed on said base and moving with said platform.

2. The apparatus according to claim 1, wherein said tooling head further comprises a pressure moderator for adjusting a pressure supplied by said tooling head.

3. The apparatus according to claim 1 further comprising an altitude adjustor disposed between said base and said platform.

4. The apparatus according to claim 1 further comprising a controller to control a process for scraping and pressing said integrated circuit.

5. The apparatus according to claim 1 further comprising a position adjustor for adjusting a position of said positioning device.

6. A method for demounting an integrated circuit, comprising steps of:
(a) placing a combination of a display panel and an integrated circuit at a first location, wherein said integrated circuit is placed on a positioning device and said display panel is placed on a platform;
(b) moving said positioning device and said platform to a second location such that a linking portion between said display panel and said integrated circuit is positioned under a tooling head;
(c) descending said tooling head for urging against said link portion; and
(d) moving said positioning device and said platform back to said first location, thereby said integrated circuit being scraped from said display panel.

7. The method according to claim 6, further comprising a step (b-1) for heating said integrated circuit to soften a glue stuck on said link portion.

8. The method according to claim 7, wherein said linking portion is heated by said positioning device.

9. The method according to claim 7, wherein said linking portion is heated by said tooling head.

10. A method for mounting an integrated circuit, comprising steps of:
(a) placing a combination of a display panel and an integrated circuit at a first location, wherein said integrated circuit is placed on a positioning device and said display is placed on a platform;
(b) moving said positioning device and said platform to a second location so that a linking portion between said display panel and said integrated circuit is positioned under a tooling head;
(c) descending said tooling head for urging against said link portion for a period of time;
(d) raising said tooling head after said period of time; and
(e) moving said positioning device and said platform back to said first location.

11. The method according to claim 10, further comprising a step (b-1) for heating said integrated circuit to soften a glue stuck on said link portion.

12. The method according to claim 11, wherein said linking portion is heated by said positioning device.

13. The method according to claim 11, wherein said linking portion is heated by said tooling head.
